(19) United States
(12) Patent Application Publication
(10) Pub. No.: US 2026/0233705 A1
(43) Pub. Date: Aug. 13, 2026

(54) UNIVERSAL WINDSHIELD WIPER ASSEMBLY

(71) Applicant: Benio Simor Kalka, Fillmore, CA (US)

(72) Inventor: Benio Simor Kalka, Fillmore, CA (US)

(21) Appl. No.: 19/533,686

(22) Filed: Feb. 9, 2026

Related U.S. Application Data
(63) Continuation-in-part of application No. 19/043,770, filed on Feb. 3, 2025, now abandoned.

(51) Int. Cl. B60S 1/26; B60S 1/08; B64D 47/00; B64F 5/10

(52) U.S. Cl. CPC B60S 1/26; B60S 1/0814; B64D 47/00; B64F 5/10

(57) ABSTRACT

A universal windshield wiper blade assembly for use with all aircraft, both commercial and military that removes the necessity of having assemblies for each individual type of aircraft in existence at locations where aircraft fly in and out. The system utilizes individual mounts for individual types of aircraft that are permanently installed and that contain preset programmed electronics that communicate with absolute position sensors embedded in the output shaft and incremental position sensors embedded in the motor that control the output to the shaft for each individual type of aircraft after which the universal windshield wiper assembly is installed thereon. The universal windshield wiper assembly includes a gear box with a shaft that attaches to a windshield wiper arm that moves and windshield wiper blade, an adapter for the geometry of a specific aircraft, an electric motor, including internally and externally commutated as well as asynchronous motors relative to each other that actuates the gear box and a motor cover.

### REFERENCE TO PRIOR APPLICATION

This application is a continuation-in-part of patent application Ser. No. 19/043,770, filed Feb. 3, 2025, which is a continuation-in-part of patent application Ser. No. 18/439,414, filed Feb. 12, 2024 for UNIVERSAL WINDSHIELD WIPER ASSEMBLY by Benio Simor Kalka.

### BACKGROUND OF THE INVENTION

### Field of the Invention

The field of this invention relates generally to the field of windshield wiper assemblies and more particularly toward a universal windshield wiper assembly that can be used for any type of aircraft, and is also a transferrable technology to any vehicle utilizing windshield wipers, such as automobiles and boats.

### Description of the Prior Art

Typically, an aircraft operated for passenger and for military has two separate and distinct motor/converters assemblies for windshield wiper blades, one for the left side and one for the right side of the aircraft cockpit. Due to a large variety of motor/converter assembly products on various aircraft, a large number of motor/converters need to be on hand for preventive and/or corrective maintenance of the windshield wiper blades.

For example, if an airline is operating five different types of aircrafts, under existing technologies, the airline would have to stock ten distinct motor/converters assemblies at every depot that it flew planes in order to prevent an aircraft on the ground (AOG) situation. AOG refers to an aircraft failure to be able to operate properly. An AOG is an unexpected event and can occur at any time due to weather or equipment failure. This kind of situation creates delays and public relations nightmares for airlines along with high costs. Large aircraft manufacturer Boeing estimates that 1 to 2 hours AOG costs between $10K to $20K. Sometimes passengers are required to deplane with the airplane providing hotel stays with paid meals and transport.

No airplane can fly without a windshield wiper. If a plane has no windshield wiper the plane is now AOG (airplane on the ground). If you have 150 passengers on a given flight, an AOG situations means that the passengers have to get off the plane and be sent to a hotel. This is nearly always the result of a windshield wiper malfunction because of the practical fact that the airlines cannot stock every motor converter for every plane they operate in every depot. From the smallest to largest, every motor/converter is different.

Additionally, with regard to windshield wiper motor/converters, they are noisy and pilots do not like the sound.

It is the primary object of the instant invention to provide a system and method for reducing and/or preventing AOG situations with regard to windshield wiper blades by providing a universal windshield wiper assembly that can be used on all aircraft.

It is a secondary object of the instant invention to provide a windshield wiper assembly that eliminates the noise products by prior art devices.

It is yet another object of the instant invention to provide a universal windshield wiper assembly that is transferrable to any vehicle utilizing windshield wipers, such as automobiles and watercraft.

### SUMMARY OF THE INVENTION

The basic embodiment of the present invention teaches a universal windshield wiper assembly set for all particular models of vehicles that utilize windshield wipers comprising: a first base plate for a first side of a particular vehicle's windshield wherein said first base plate for said particular vehicle includes preset programmed electronics specific to said particular vehicle for permanent installation thereon; a first universal windshield wiper assembly, said first universal windshield wiper assembly further comprising: a first gear box; a first shaft attached to said first gear box for affixing to a first windshield wiper arm, said first shaft being specifically adapted for said particular vehicle; a first motor to turn said first gear box; a first encoder embedded in said first motor; wherein said first windshield wiper assembly is affixable on said first base plate; a second base plate for a second side of said particular vehicle's windshield wherein said second base plate for said particular vehicle includes preset programmed electronics specific to said particular vehicle for permanent installation thereon; a second universal windshield wiper assembly, said second universal windshield wiper assembly further comprising: a second gear box; a second shaft attached to said second gear box for affixing to a second windshield wiper arm, said second shaft being specifically adapted for said particular vehicle; a second motor to turn said second gear box; a second encoder embedded in said second motor; wherein said second windshield wiper assembly is affixable on said second base plate.

The above embodiment can be further modified by defining that said first and second motors are internally commutated.

The above embodiment can be further modified by defining that said first and second motors are externally commutated.

The above embodiment can be further modified by defining that said first and second motors are asynchronous relative to each other.

An alternate embodiment of the instant invention provides for a method of installing a universal windshield wiper assembly set on all models of aircraft, said method comprising the steps of: providing a first assembly of said assembly set, said first assembly further comprising: a first gear box; a first shaft attached to said first gear box for affixing to a first windshield wiper arm, said first shaft being specifically adapted for a particular type of aircraft; a first motor to turn said first gear box; a first encoder embedded in said first motor wherein said first windshield wiper assembly is affixable to a first base plate, said first base plate having pre-set programmed electronics embedded therein for control of said first windshield wiper assembly configured for said particular type of aircraft; providing a second assembly of said assembly set, said second assembly further comprising: a second gear box; a second shaft attached to said second gear box for affixing to a second windshield wiper arm, said second shaft being specifically adapted for a particular type of aircraft; a second motor to turn said second gear box; a second encoder embedded in said second motor wherein said second windshield wiper assembly is affixable to a second base plate, said second base plate having pre-set programmed electronics embedded therein for control of said second windshield wiper assembly configured for said particular type of aircraft; installing said first base plate on a first side of a particular aircraft's windshield; installing said second base plate on a second side of said particular aircraft's windshield; testing on said first side of said particular aircraft; and testing on said second side of said particular aircraft.

The above embodiment can be further modified by defining that said first and second motors are internally commutated.

The above embodiment can be further modified by defining that said first and second motors are externally commutated.

The above embodiment can be further modified by defining that said first and second motors are asynchronous relative to each other.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is an exploded view of an exemplary prior art system for windshield wiper assemblies for aircraft.

FIG. 2A is top perspective view of the assembled universal windshield wiper assembly of the instant invention.

FIG. 2B is a top plan view of the assembled universal windshield wiper assembly of the instant invention.

FIG. 3 is a flow chart indicating the use and parts of the universal windshield wiper assembly of the instant invention.

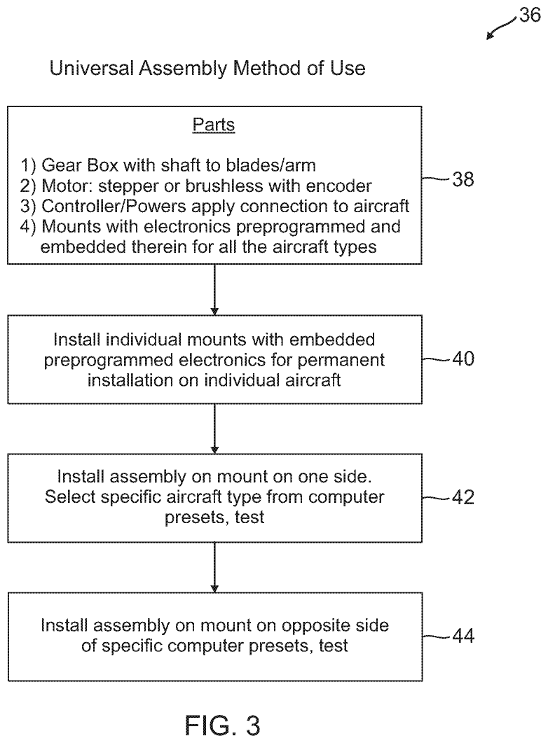

### DETAILED DESCRIPTION OF A PREFERRED EMBODIMENT

Turning to the drawings, the preferred embodiment is illustrated and described by reference characters that denote similar elements throughout the several views of the instant invention.

The preferred embodiment of the instant invention provides for a convertor style motor/gearbox assembly for use in a universal windshield wiper assembly. The converter is the device that turns the rotary motion of the motor into the reversible action of the windshield wiper, just like on a car. The instant invention uses an electric motor, including internally and externally commutated as well as asynchronous motors, which allows the gear to go back and forth over a set number of degrees. The motor can be instructed electronically regarding how much torque to put out to match the requirement of an individual plane. Similarly, the number of degrees that the wipers will swing and the parking position can be programmed electronically as well. The torque, the degree of swing, the speed and the parking position are programmable for each individual aircraft. There is no need, with the instant system, to replace the switch that turns on and sets the speeds. The instant invention seeks to simplify modern automotive systems which have features such as automatically turning on when rain starts, which is not desired by the instant design.

The lifetime of a bolt style prior art motor converters is five years. The cost is $25-45K a piece and there are two on each airplane. The instant invention seeks to build a different frame than what exists to hold a motor converter, which in the instant system is really a motor gear box rather than a motor converter, which is the terminology for prior existing systems. In order to mount the gear box of the instant system, there are different mounting platforms which are individual and different for each side of each aircraft never need to be replaced, i.e., it would never come off again and would become a permanent installation.

Airlines operate their airplanes in terms of safety considerations. According to a series of checks, ending with a d-check which is a complete demobilization of the aircraft, i.e., the removal of major systems like the panel, making it entirely accessible. To install and use the instant system, the mount is installed which is coded to detect and indicate the specific individual plane type and which side of the windshield the assembly is located. Like testers you have on a car, this process takes only a matter of seconds, after which, assembly should be easy and clean. Preliminary coding and testing will provide that the motor knows the torque, speed and other requirements of the original specification that the aircraft manufacturer previously provided.

The assembly is universal and would fit in all airplanes and helicopters whether or not it is an aircraft with a pair of one-piece motor converters, or a system that operates with one motor driving two separate converters using flexible shafts to turn the converter. The instant invention uses a specialized motor/converter assembly that uses an electric motor, including internally and externally commutated as well as asynchronous motors relative to each side which typically lasts longer than the traditional DC electric motors used in windshield wipers. The manufacturing costs of internally and externally commutated and asynchronous motors have come down considerably making them an even more competitive option. Furthermore, these stepper and brushless motors are stronger and have more torque over other styles of motor. The motors use an optical encoder to tell the system where the motor is, essentially created a closed loop system.

One of the disadvantages of current systems is the noise especially of the converter, which is eliminated by the instant system Internally and externally commutated and asynchronous motors have the additional advantage of being quieter than traditional DC motors. Further, internally and externally commutated and asynchronous motor assemblies have fewer moving parts, which makes them less susceptible to breakage.

While the time needed to replace the motor will remain about the same, the fact of universality of the method provides a remedy for situations when windshield wipers on aircraft need changing without the need for multiple styles being kept in stock at each depot. The three main components in the assembly are as follows: the Internally and externally commutated motors with the motors being asynchronous relative to each other, a chip controller housed inside permanent mounts on the windshield of the specific type of aircraft, and a motor driver. There are no complicated levers or gears. The SMC sends an input pulse signal to the driver, which in turn provides the power to turn the motor. The individual mounts are an integral part of the system and are programmable for each aircraft model. Once programmed, the controller chip inside the individual mounts will tell the system: (a) the sweep range of the wiper blade, (b) the home position (parking place), (c) the wiping speed and (d) type of cycle.

A controller, which is a chip mounted in each of the mounts for each assembly adjusts the power going to the shaft. Since the controller is in the mount, it is always on the aircraft, i.e., once installed, there is no further need for alignment. The controller communicates with an absolute position sensor mounted in the output shaft of the gear box of the assembly and is environmentally sealed, always knowing its position in space. Additionally, an incremental sensor is mounted on the motor. The absolute sensor measures the position of the output shaft, always knowing its position in space. It is a closed loop system with motion control. The absolute position sensor is environmentally sealed and always knows where it is and does not have to detect proximity to any other objects. It controls the position of the blade at all times as well as the power directed to the shaft as needed and monitors its current position within the limits of the motor.

Each assembly also includes adaptors that may be different on each side. The adapters are individual to each individual style of aircraft. The adapters shafts will vary in length and diameter as well as in spline count. The output shaft of the driver is of a certain length, but the mounting position of the system and fuselage geometry varies across different aircraft platforms as well as the diameter and splines of the shaft that the wiper arms connect to. The adapter shaft of the instant invention therefore has to accommodate each aircraft model's design. The shaft will stay with the aircraft as does the mount.

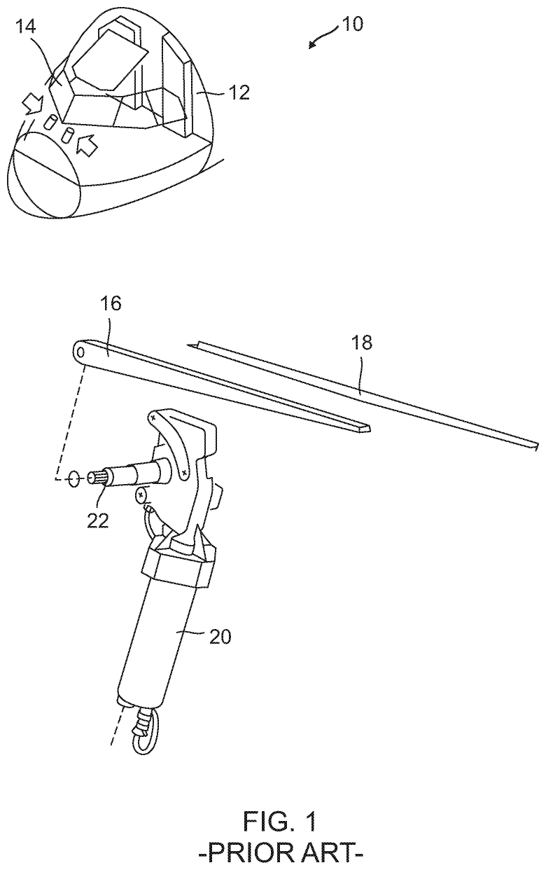

FIG. 1 illustrates a typical prior art assembly 10. Illustrated is the cockpit 12 of an airplane where the windshield 14 is shown. The windshield 14 is where the wiper blade assembly would be affixed. Existing systems include a motor with a shaft 22 that attaches to a wiper arm 16 that moves a wiper blade 18. Each type aircraft has its own specifications and hence the assembly is individual to each type of aircraft. As explained, the instant invention seeks to simplify the system to individual mounts with preset programmed embedded electronics for each plane, that work with a motor/gearbox assembly 26.

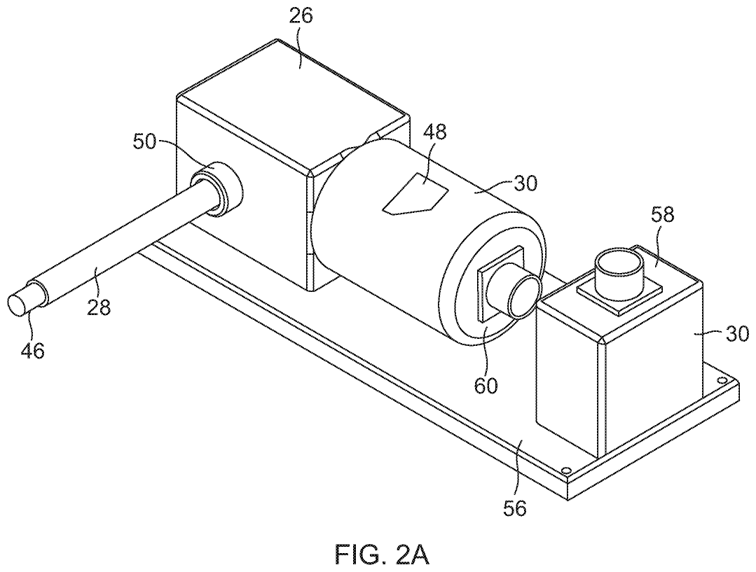

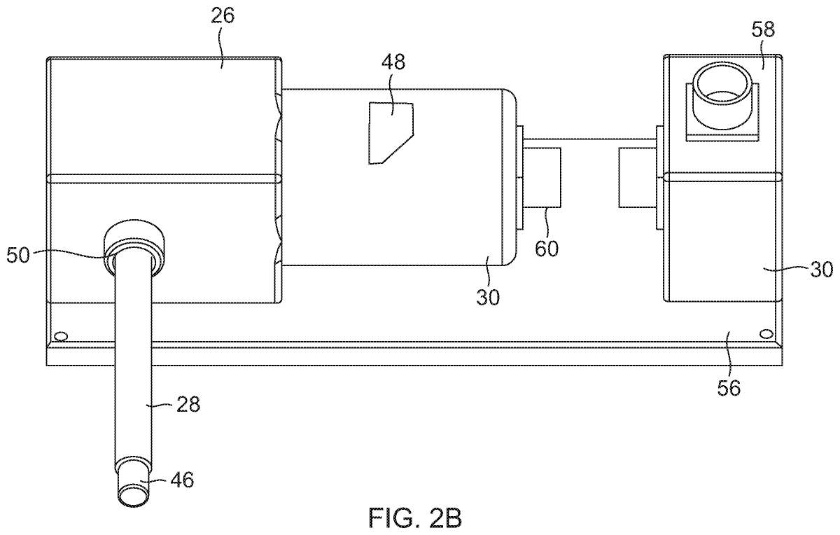

There is a base plate 56 that mounts to an aircraft at existing mounting points on the aircraft and are positioned near the windshield 14 on the cockpit 12 of an individual aircraft. The assembly of the instant invention is composed of three main components, shown in FIGS. 2A-2B. These main components are the gear box 26 with rotating shaft 28. The shaft 28 itself is an adapter that will vary from aircraft to aircraft and vary in length and/or diameter. On one end of the shaft 28 is a mounting member 46 that has the specific splines required for connection with the applicable wiper arm mounting head (not shown). On the other end of the shaft 28 is a receiving hole 50 that is always the same and matches the output of the gearbox 26 which is attached to the shaft 28. The output of the gearbox 26 includes a short splined shaft that then in turn plugs into the bottom of the adapter shaft 28.

The base plate 56 is a controller/power supply 30 attached thereto. The controller/power supply 30 has proximate thereto a connection point 58 for attachment to the aircraft. The power/controller 30 also has attachment points 60 to the motor 30 that also mounts to the base plate 56. The motor 30 has at least one built-in encoder 48 that connects to the controller 30 through the connection point 60.

The base plate 56 has electronics embedded therein that are programmed such that the controller 30 can operate the assembly for any type of aircraft for which the electronics have been programmed. The motor 30 gets fitted with the shaft 28 for that plane and installed on the base plate 56. Because of this, the same motor 30 can be installed on various base plates 56 with their specific controllers 30 and different shafts 28.

The electric motor includes choices between internally and externally commutated as well as asynchronous motors relative to each other. Inside of the base plate 56 are housed the electronics that are programmed with presets for the specifications of each type of aircraft and that are in communication with the encoder 48 in the motor 30.

FIG. 6 is a flow chart 36 illustrating the method of use of the universal wiper blade assembly 24 of the instant invention. The first step 38 is assembly of the parts of the universal assembly, which includes the gear box with shaft to connect to the wiper arm and blade, the motor with encoder, the controller/power supply connection to the aircraft and the base plate 56 that has embedded therein preset programmed electronics. The second step 40 is the installation of the preprogrammed individual mounts 46 for permanent installation on an individual aircraft. The third step 42 is the installation on the mount 46 of one side of the windshield, selecting the preset for the individual aircraft and the testing. Once found to be successful, the final step 44 is the installation on the mount 46 on the opposing side of the windshield, selecting the same preset for the individual aircraft and performing the final test.

Now that the invention has been described in detail as it applies to aircraft, it is to be understood that the system and devices can easily be transferred to any vehicle that utilizes windshield wipers, such as automobiles and watercraft.

The invention illustratively disclosed herein suitably may be practiced in the absence of any element which is not specifically disclosed herein.

The discussion included in this detailed description is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. A universal windshield wiper assembly set for all particular models of vehicles that utilize windshield wipers comprising:
a first base plate for a first side of a particular vehicle's windshield wherein said first base plate for said particular vehicle includes preset programmed electronics specific to said particular vehicle for permanent installation thereon;
a first universal windshield wiper assembly, said first universal windshield wiper assembly further comprising:
a first gear box;
a first shaft attached to said first gear box for affixing to a first windshield wiper arm, said first shaft being specifically adapted for said particular vehicle;
a first motor to turn said first gear box;
a first encoder embedded in said first motor;
wherein said first windshield wiper assembly is affixable on said first base plate;
a second base plate for a second side of said particular vehicle's windshield wherein said second base plate for said particular vehicle includes preset programmed electronics specific to said particular vehicle for permanent installation thereon;
a second universal windshield wiper assembly, said second universal windshield wiper assembly further comprising:
a second gear box;
a second shaft attached to said second gear box for affixing to a second windshield wiper arm, said second shaft being specifically adapted for said particular vehicle;
a second motor to turn said second gear box;
a second encoder embedded in said second motor;
wherein said second windshield wiper assembly is affixable on said second base plate.

2. The universal windshield wiper assembly set as defined claim 1 wherein said first and second motors are internally commutated.

3. The universal windshield wiper assembly set as defined in claim 1 wherein said first and second motors are externally commutated.

4. The universal windshield wiper assembly set as defined in claim 1 wherein said first and second motors are asynchronous relative to each other.

5. A method of installing a universal windshield wiper assembly set on all models of aircraft, said method comprising the steps of:
providing a first assembly of said assembly set, said first assembly further comprising:
a first gear box;
a first shaft attached to said first gear box for affixing to a first windshield wiper arm, said first shaft being specifically adapted for a particular type of aircraft;
a first motor to turn said first gear box;
a first encoder embedded in said first motor wherein said first windshield wiper assembly is affixable to a first base plate, said first base plate having pre-set programmed electronics embedded therein for control of said first windshield wiper assembly configured for said particular type of aircraft;
providing a second assembly of said assembly set, said second assembly further comprising:
a second gear box;
a second shaft attached to said second gear box for affixing to a second windshield wiper arm, said second shaft being specifically adapted for a particular type of aircraft;
a second motor to turn said second gear box;
a second encoder embedded in said second motor wherein said second windshield wiper assembly is affixable to a second base plate, said second base plate having pre-set programmed electronics embedded therein for control of said second windshield wiper assembly configured for said particular type of aircraft;
installing said first base plate on a first side of a particular aircraft's windshield;
installing said second base plate on a second side of said particular aircraft's windshield;
testing on said first side of said particular aircraft; and
testing on said second side of said particular aircraft.

6. The method as defined in claim as defined claim 5 wherein said first and second motors are internally commutated.

7. The method as defined in claim 5 wherein said first and second motors are externally commutated.

8. The method as defined in claim 5 wherein said first and second motors are asynchronous relative to each other.
